(19) United States
(12) Patent Application Publication
(10) Pub. No.: US 2011/0184984 A1
(43) Pub. Date: Jul. 28, 2011

(54) SEARCH TERM VISUALIZATION TOOL

(75) Inventor: CHRISTOPHER E. GETNER, ARLINGTON, VA (US)

(73) Assignee: HURON CONSOLUTING GROUP, CHICAGO, IL (US)

(21) Appl. No.: 12/695,183

(22) Filed: Jan. 28, 2010

(51) Int. Cl. G06F 17/30; G06F 3/048

(52) U.S. Cl. 707/779; 715/764; 707/E17.016

(57) ABSTRACT

A system, computerized method, and program product for visualizing an effect of search terms on search results. This may include a storage device configured to store a computer program and a data source. The data source could include a plurality of search terms that are associated with a first search result factor and a second search result factor. Typically, the first search result factor represents a first search result characteristic and the second relevance factor represents a second search result characteristic. The search terms may be arranged on a coordinate system such that the first relevance factor corresponds to a first axis of the coordinate system and the second relevance factor corresponds to a second axis of the coordinate system. A graphical representation of the search terms may be displayed according to the arrangement of search terms on the coordinate system.

### TECHNICAL FIELD

This invention generally relates to computerized processes, computer systems and computer program code for visualizing an effect of search terms on search results; in particular, the invention relates to a visualization tool and process that allows a user to graphically analyze search terms in a relativistic fashion.

### BACKGROUND

In many situations, a multiplicity of electronic documents must be searched for various criteria. For example, electronic discovery in litigation is now mandated by the Federal Rules of Civil Procedure. The parties must review thousands (if not millions) of electronic documents to determine relevance, privilege, issue coding, etc. This issue arises in other contexts as well, such as compliance with corporate policies, Sarbanes-Oxley compliance, etc.

When reviewing these documents, varying search terms may be used to categorize documents. The formulation of an effective search query can be important to identify the most desired documents matching certain criteria and can be a strategic advantage to one party during a litigation matter. However, it can be difficult to analyze the impact of search terms on the overcall results of a query.

Therefore, there exists a need for a novel system and method for analyzing the impact of various search terms on the results of a query.

### SUMMARY

According to one aspect, the present invention provides a system for visualizing an effect of search terms on search results. The system may include a storage device configured to store a computer program and a data source. The data source could include a plurality of search terms that are associated with a first search result parameter and a second search result parameter. Typically, the first search result parameter represents a first search result characteristic and the second search result parameter represents a second search result characteristic;

The system includes a processor in communication with the storage device. A computer program is operable, when executed by the processor, to cause the processor to perform certain steps. The search terms may be arranged on a coordinate system such that the first search result parameter corresponds to a first axis of the coordinate system and the second search result parameter corresponds to a second axis of the coordinate system. A graphical representation of the search terms may be displayed according to the arrangement of search terms on the coordinate system.

In one embodiment, the coordinate system includes a Cartesian coordinate system. For example, the first search result parameter could correspond to the x-axis and the second search result parameter could correspond to the y-axis. In some cases, each search term could be graphically represented as a point with Cartesian coordinates defined by the first search result parameter and the second search result parameter. Typically, the point may be graphically represented by a circle, oval, rectangle, square, triangle, or polygon. Embodiments are contemplated in which each point representing a search term has a relative size indicative of a number of hits for the search term.

Depending on the circumstances, the first search result characteristic could indicate a proportional number of hits with parent/child relationships for a search term. In some embodiments, the second search result characteristic may indicate a proportional number of hits for unique documents with a search term. In some cases, the processor could remove a search term from the analysis upon receiving a selection of that search term. The selected search term could be categorized responsive to input from the user.

According to another aspect, the invention provides a system for visualizing an effect of search terms on search results that includes search term analysis data, a visualization module, a search term calibration module, and a categorization log. The search term analysis data includes a plurality of search terms associated with at least one search results parameter. The visualization module is configured to graphically represent the search results parameter associated with the plurality of search terms in the search term analysis data in a relativistic fashion. The search term calibration module is configured to categorize the plurality of search terms into at least a first category and a second category responsive to selection by the user. The categorization log is configured to store data concerning categorization of the plurality of search terms.

According to a further aspect, the invention provides a non-transitory computer-readable storage medium with an executable program stored thereon for visualizing an effect of search terms on search results. The program instructs a processor to perform steps including a step of providing search term analysis data for a plurality of search terms that are associated with a first search result parameter and a second search result parameter. The first search result parameter represents a first search result characteristic and the second search result parameter represents a second search result characteristic. The plurality of search terms are arranged on a coordinate system such that the first search result parameter corresponds to a first axis of the coordinate system and the second search result parameter corresponds to a second axis of the coordinate system. A graphical representation of the search terms is displayed according to the arrangement of search terms on the coordinate system.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF THE DRAWINGS

The present disclosure will be described hereafter with reference to the attached drawings which are given as non-limiting examples only, in which:

FIG. 1 is block diagram of an example machine that could be used to operate the visualization tool according to an embodiment of the present invention;

FIG. 2 is a block diagram of the visualization tool according to an embodiment of the present invention;

FIGS. 3-14 are various screen shots showing operation of the visualization tool in different examples; and

FIG. 15 is a flow chart showing various steps that may be performed during the operation of the visualization tool.

Corresponding reference characters indicate corresponding parts throughout the several views. The exemplification set out herein illustrates example embodiments of the invention, and such exemplification is not to be construed as limiting the scope of the invention in any manner.

### DETAILED DESCRIPTION OF THE DRAWINGS

It is to be understood by one of ordinary skill in the art that the present discussion is a description of exemplary embodiments only, and is not intended as limiting the broader aspects of the present invention, which broader aspects are embodied in the exemplary constructions.

This disclosure relates generally to a computerized system and method for graphically representing and analyzing the relative affect of search terms on the search results of a data set (e.g., electronic documents). In one aspect, for example, a variety of search result parameters or characteristics for the search terms may be graphically represented in a relativistic fashion, including but not limited to the number of hits for the search term, the number of unique documents with the search term, and the number of documents with family relationships having the search term. For example, the search terms may be plotted on a coordinate system based on relative search result parameters.

The graphical representation focuses attention on the most important search terms. In addition, this allows search term lists to be categorized into terms that are helpful (e.g., search terms that are delivering the hits that were intended) that should be kept, and unhelpful search terms that the user may want to revisit, modify, or potentially edit or delete. As should be appreciated by one of skill in the art, the present disclosure may be embodied in many different forms, such as one or more machines, computerized methods, data processing systems or computer program products.

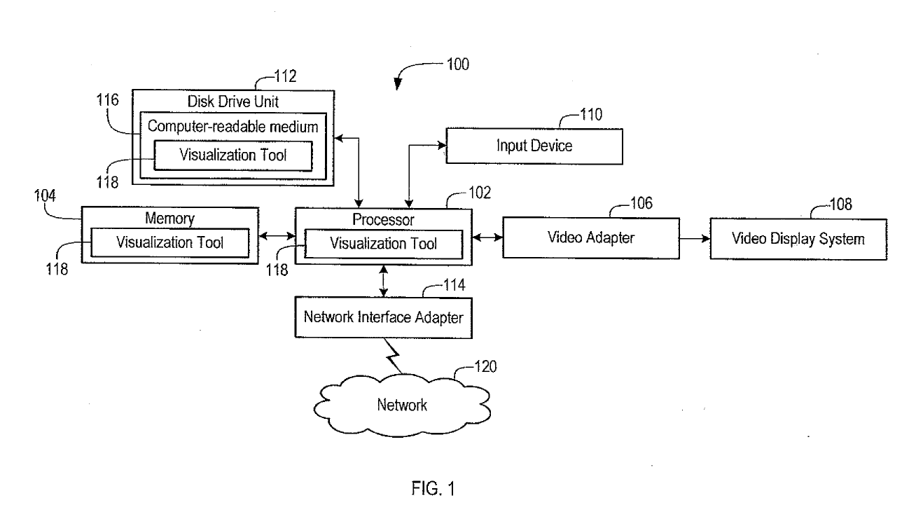

FIG. 1 illustrates a diagrammatic representation of a machine 100 in the example form of a computer system that may be programmed with a set of instructions to perform any one or more of the methods discussed herein. The machine may be a personal computer, a tablet computer, a Personal Digital Assistant (“PDA”), a media player, a cellular telephone, or any machine capable of executing a set of instructions (sequential or otherwise) that specify actions to be taken by that machine.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. In embodiments where the computer program is locally stored, data may be retrieved from local storage or from a remote location via a network. In one embodiment, the computer program and data may be bundled together in a single file. For example, the program may be a Java applet and the data along with any components could be bundled together as a Java Archive (“JAR”) file. In this example, the JAR file could be communicated, such as via email, and executed by numerous types of machines that may have divergent hardware and run a variety of operating systems, including Windows, Linux, Mac OS, etc. In a networked deployment, the machine 100 may operate in the capacity of a server or a client machine in server-client network environment, or as a peer machine in a peer-to-peer (or distributed) network environment. Although only a single machine is illustrated in FIG. 1, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a search term visualization tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the search term visualization tool 118 may be transmitted or received over a network 120 via the network interface device 114 utilizing any one of a number of transfer protocols including but not limited to the hypertext transfer protocol (“HTTP”) and file transfer protocol (“FTP”). The network 120 may be any type of communication scheme including but not limited to fiber optic, wired, and/or wireless communication capability in any of a plurality of protocols, such as TCP/IP, Ethernet, WAP, IEEE 802.11, or any other protocol.

While the computer-readable medium 116 is shown in the example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

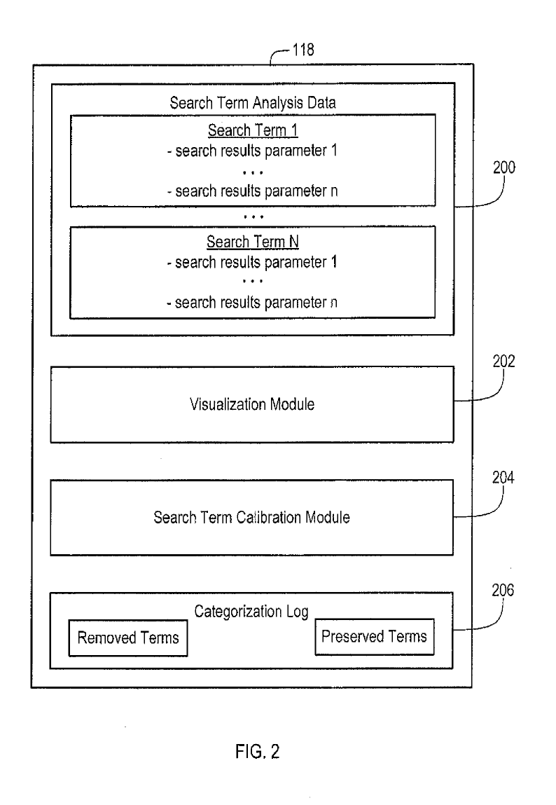

FIG. 2 is a block diagram showing an embodiment with various modules that may be included in the search term visualization tool 118. In the embodiment shown, the search term visualization tool 118 includes search term analysis data 200, a visualization module 202, a search term calibration module 204, and a categorization log 206. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

The search term analysis data 200 provides information concerning the search results associated with a plurality of search terms or search concepts. For example, each search term may be associated with one or more search result parameters that indicate characteristics of a search result associated with the search term. By way of example only, the search results parameters associated with a search term could include, but are not limited to the total number of hits for that term, the number of those hits with family relationships (e.g., parent and/or child documents), and the number of documents that uniquely hit on that search term.

Consider an example in which a data set is searched that includes one million documents and the search query included the search term “profits.” In this example, the search results may reveal 16,434 total hits (i.e., the total number of documents that included the word “profits”), 3,425 unique documents (i.e., the total number of documents that included the term “profits,” but no other search terms in the query), and 2,167 documents with family relationships (i.e., documents with a relationship to other documents, such as an email with various attachments) associated with the term “profits.” Thus, the search term analysis data may include “total hits” as one of the search results parameters for the search term “profits” with a value of 16,434. The number of unique documents could be another search results parameter with a value of 3,424. Likewise, the number of family documents could be another search results parameter and would have a value of 2,167.

Consider another example in which the search uses a concept search engine that allows searching/clustering of documents by concept. This type of search would differ from a keyword search in that a concept search may understand the context of words in a document and other words that are often linked to the concept. For example, a search for the “damages” concept may elicit documents that include the words “profit,” “bottom line,” “price,” etc. When a concept search is used, the search results characteristics may be grouped for each concept. Keyword searches, concept searches, and other types of search techniques are encompassed by this disclosure. A search analysis product sold under the name IDOL™ Server by Autonomy, Inc. of San Francisco, Calif. could be used to determine a variety of search results parameters for respective search terms or concepts in a query.

The visualization module 202 is configured to graphically represent the search results parameters associated with search terms in the search term analysis data in a relativistic fashion. In one embodiment, the visualization module 202 arranges the search terms on a coordinate system based on search results parameters. In one embodiment, for example, the visualization module 202 may arrange points on a coordinate system representing search terms in which the relative coordinates of the points correspond with the relative magnitude of search results parameters for the various search terms. For example, a first search results parameter may correspond to a first axis and a second search results parameter may correspond to a second axis.

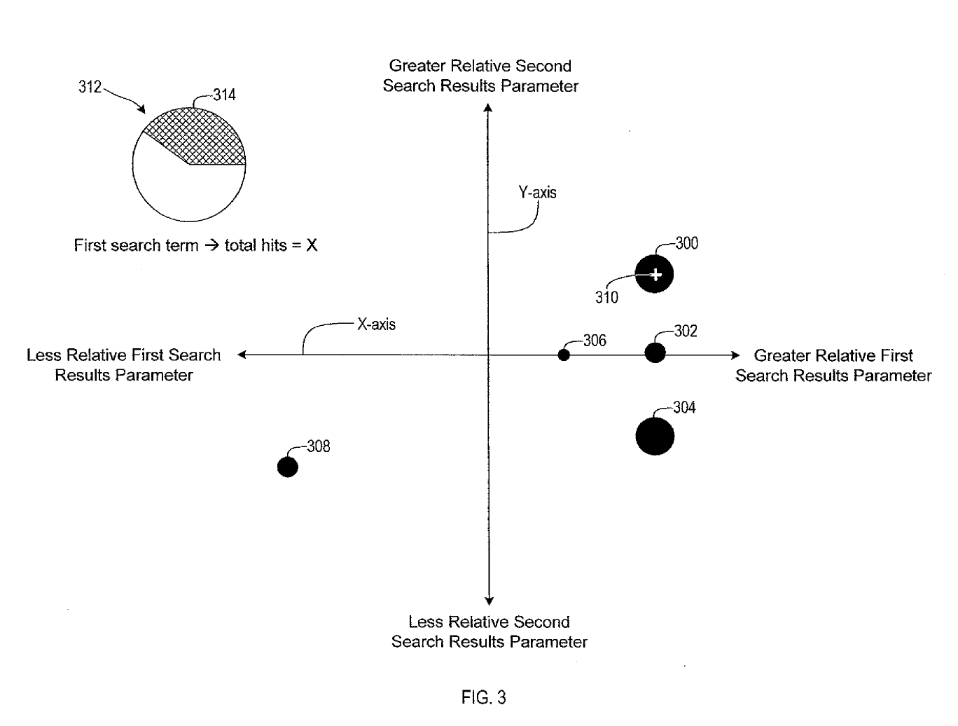

Consider the example in FIG. 3 that uses the Cartesian coordinate system. In this example, a first search results parameter corresponds with the X-axis and a second search results parameter corresponds with the Y-axis. This example includes a first point representing a first search term 300, a second point representing a second search term 302, a third point representing a third search term 304, a fourth point representing a fourth search term 306, and a fifth point representing a fifth search term 308. Due to the graphical nature of the coordinate system with which the relationships of various search results parameters are arranged in a relative manner, a user can easily understand the relative relationships of these search terms with respect to the first and second search results parameters. For example, the user could understand that the first search term 300 was similar to the second search term 302 and third search term 304 with respect to the first search results parameter because each of these search terms 300, 302, 304 have similar relative X-coordinates. Likewise, the user would understand that the second search term 302 and fourth search term 306 are relatively similar with respect to the second search results parameter because both search terms 302, 306 have similar Y-coordinates. The user would also glean that the second search term 302 is greater with respect to the second search results parameter relative to the third search term 304, but smaller relative to the first search term 300 due to the relative Y-axis coordinates. The user would also understand that the first search term 300 has a much greater weight relative to the fifth search term 308 with respect to both the first and second search results parameters due to the relatively greater X and Y coordinates of the first search term 300 with respect to the fifth search term 308.

The example in FIG. 3 also indicates the relative weight of the search terms 300, 302, 304, 306, 308 with respect to a third search results parameter due to the relative size of the points representing the search terms 300, 302, 304, 306, 308. For example, the user would understand that the fifth search term 308 is relatively greater than the fourth search term 306 with respect to the third search results parameter, but relatively less than the first and third search terms 300, 304 due to the relative size of points representing the various search terms. Although the example in FIG. 3 uses circles to represent the search terms 300, 302, 304, 306, 308, embodiments are contemplated in which the graphical representation of search terms on the coordinate system could be a variety of shapes or symbols, including but not limited to ovals, rectangles, squares, triangles, and polygons. Likewise, in some embodiments, a combination of various shapes could be used.

Referring again to FIG. 2, the search term calibration module 204 is configured to categorize search terms to be preserved or deleted/edited responsive to selection(s) by the user. For example, the user may select one or more of the points on the graphical representation to categorize the selected search term as desired. In one embodiment, the search term calibration module 204 removes the selected search term from the list of search terms so that the visualization module 202 can graphically represent the remaining search terms that have not been categorized. This allows the relative effect of the remaining search terms to be graphically represented for analysis by the user. The search term calibration module is operatively connected with the categorization log 206 for storing data concerning terms to be preserved in the search query and those terms that should be deleted or edited in the query. In some embodiments, information in the categorization log 206 may be visible to the user so that the previous analysis of the search terms can be viewed. In one embodiment, the search term calibration module 204 may provide additional information about the selected search term, such as one or more search results parameters for the selected search term or other information. For example, an embodiment is contemplated in which the relative portion of the selected search term could be graphically represented, such as using a pie chart or other graphical representation.

FIGS. 3-7 show a manner of analyzing the impact of search terms on the search results and categorizing search terms as desired according to one embodiment. As discussed above, FIG. 3 shows an embodiment that uses the Cartesian coordinate system in which a first search results parameter corresponds with the X-axis, a second search results parameter corresponds with the Y-axis, and the relative size of the points representing the search terms corresponds with a third search results parameter. As shown, a cursor 310 is positioned over the point representing the first search term 300, which provides information about the first search term 300. In the example shown, the user is shown that the first search term 300 has “X” total hits. Additionally, in this example, a pie chart 312 is provided with the approximate portion 314 of the search query corresponding with the first search term 300.

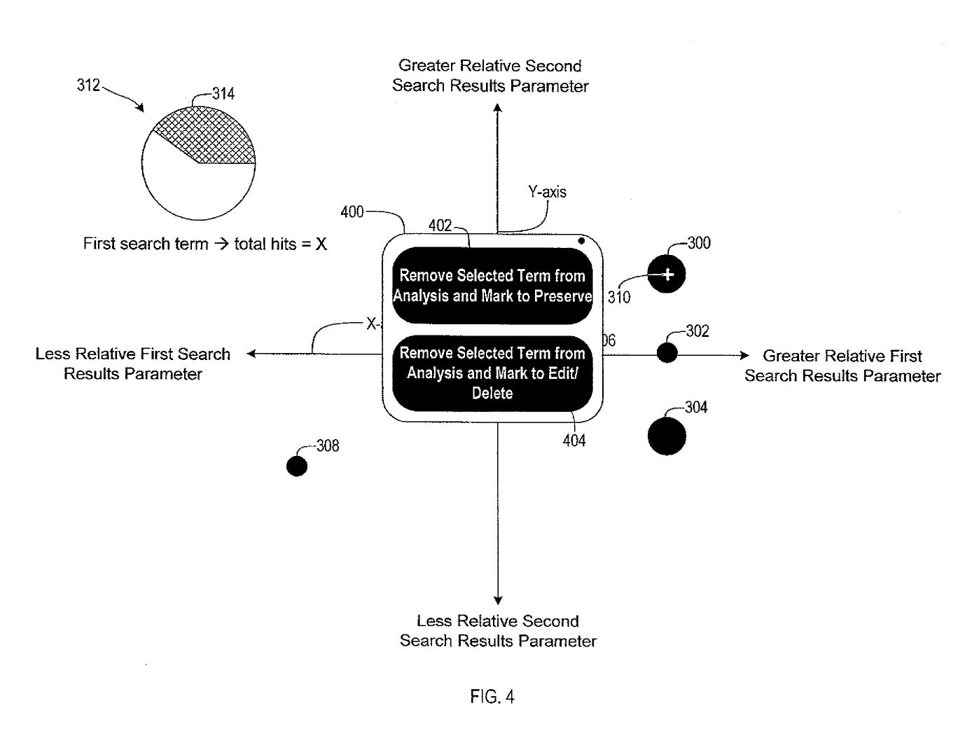

FIG. 4 shows an example screen that may appear if a user selected the first search term 300 for categorization, such as by clicking on the point corresponding with the first search term 300 with a mouse or other input device 110. In this example, the search term calibration module 204 presents the user with a window 400 in which the user can select either a first categorization option 402 or a second categorization opinion 404. In the example shown, selection of the first categorization option 402 by the user will cause the search term calibration module 204 to categorize the selected search term as a search term to preserve in the search query. If the user selects the second categorization option 404 in this example, the search term calibration module 204 will categorize the selected search term as a search term to remove/edit in the search query. In this example, the selection of either option 402, 404 removes the selected term from the graphical representation of search terms, which allows the user to view the relative relationships between the remaining search terms with respect to the first, second, and third search results parameters. As discussed above, the categorization of search terms may be stored in the categorization log 206.

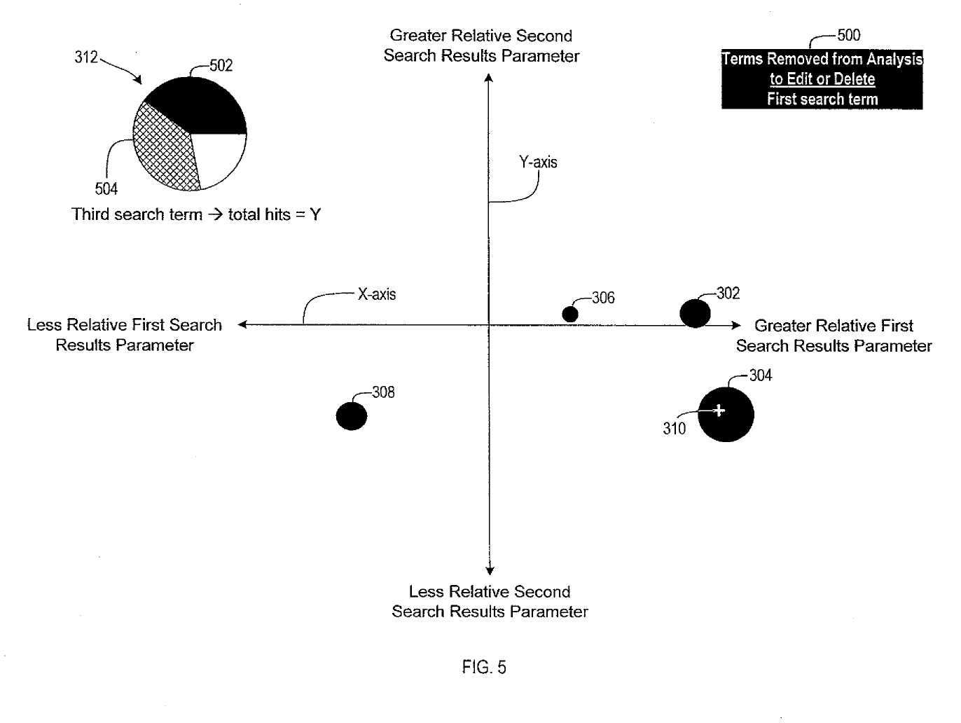

FIG. 5 shows an example screen shot in the example where the first search term 300 is removed from the graphical representation and categorized as a term to be edited/removed from the search query 500. In the example shown, it can be seen that the relative positions of the remaining search terms 302, 304, 306, 308 have been recalculated because the first search term 300 has been removed and is therefore not considered in the graphical representation of the first and second search results parameters. Likewise, in this example shown, the relative size of the search terms 302, 304, 306, 308 have changed to account for the removal of the first search term 300 from the graphical representation. In this example, which includes a pie chart 312, the portion corresponding with the removed first search term 300 is identified as a slice 502 in the chart. Additionally, in this example, the pie chart 312 provides the approximate portion 504 of the search query corresponding with the third search term 304 because the cursor is positioned on the representation of the third search term 304.

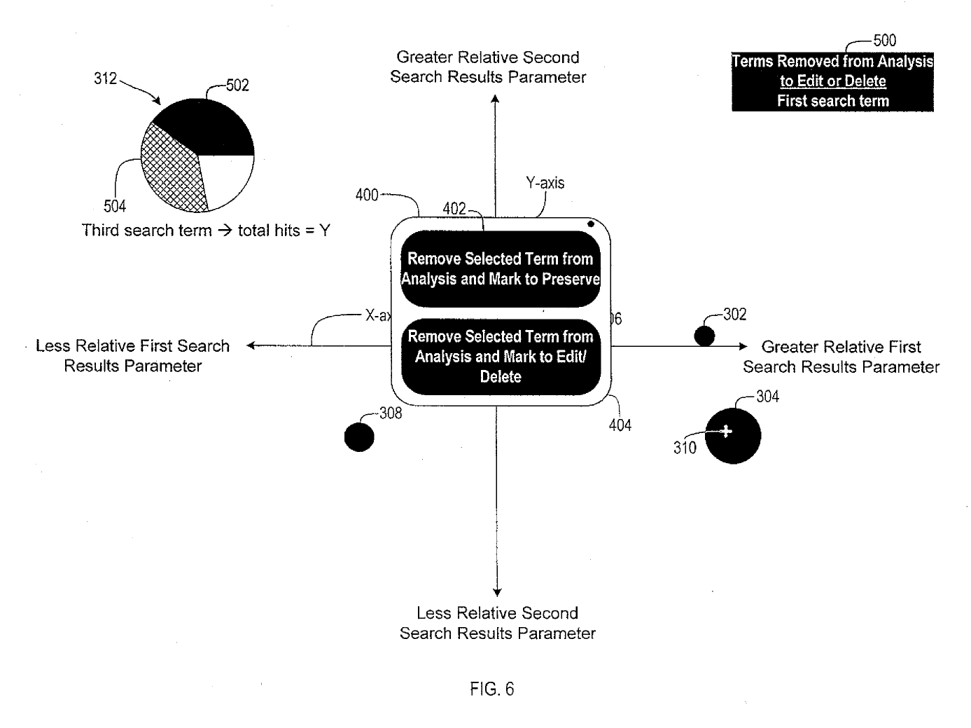

FIG. 6 shows an example screen that may appear if a user selected the third search term 304 for categorization, which is similar to the discussion above with respect to FIG. 4 when the first search term 300 was selected by the user. In this example, the search term calibration module 204 presents the user with a window 600 in which the user can select either a first categorization option 602 or a second categorization opinion 604. In the example shown, selection of the first categorization option 602 by the user will cause the search term calibration module 204 to categorize the selected search term as a search term to preserve in the search query. If the user selects the second categorization option 604 in this example, the search term calibration module 204 will categorize the selected search term as a search term to remove/edit in the search query. In this example, the selection of either option 602, 604 removes the selected term from the graphical representation of search terms, which allows the user to view the relative relationships between the remaining search terms with respect to the first, second, and third search results parameters. As discussed above, the categorization of search terms may be stored in the categorization log 206.

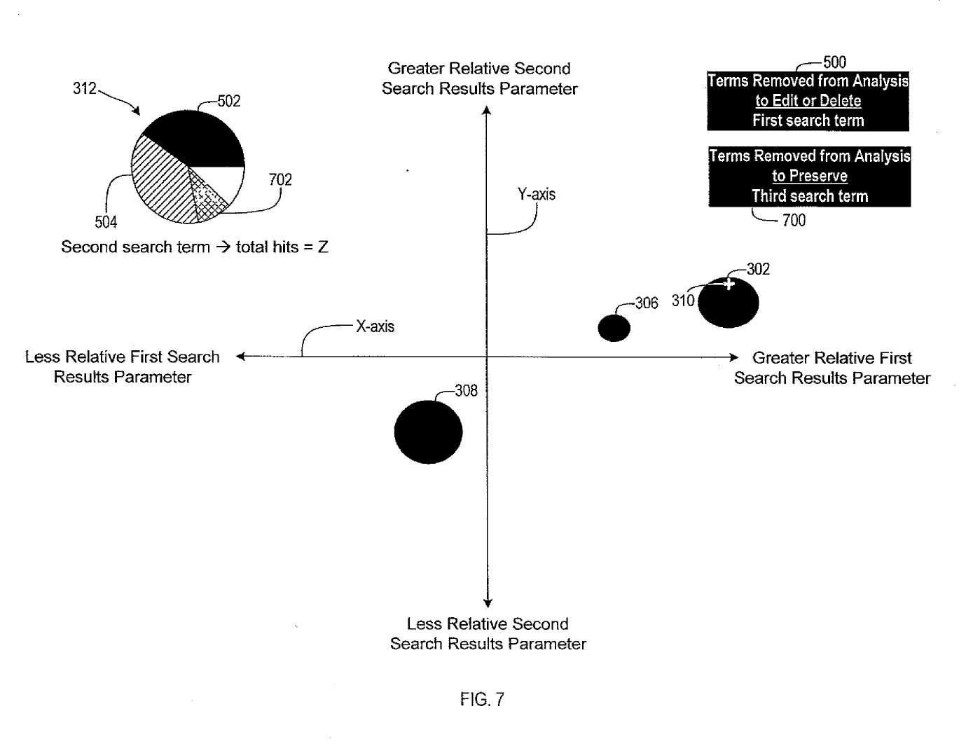

FIG. 7 shows an example screen shot in the example where the third search term 304 is removed from the graphical representation and categorized as a term to be preserved from the search query 700. In the example shown, it can be seen that the relative positions of the remaining search terms 302, 306, 308 have been recalculated because the third search term 304 has been removed and is therefore not considered in the graphical representation of the first and second search results parameters. Likewise, in this example shown, the relative size of the remaining search terms 302, 306, 308 have changed to account for the removal of the third search term 304 from the graphical representation. The pie chart 312 has been updated, in this example, to reflect that the portion 504 corresponding to the third search term 304 has been categorized as a term to preserve in the search query. One skilled in the art should appreciate that there are numerous manners of graphically reflecting the categorization of the third search term in the pie chart 312, including but not limited to the color and fill pattern. Additionally, in this example, the pie chart 312 provides the approximate portion 702 of the search query corresponding with the second search term 302 because the cursor is positioned on the representation of the second search term 302.

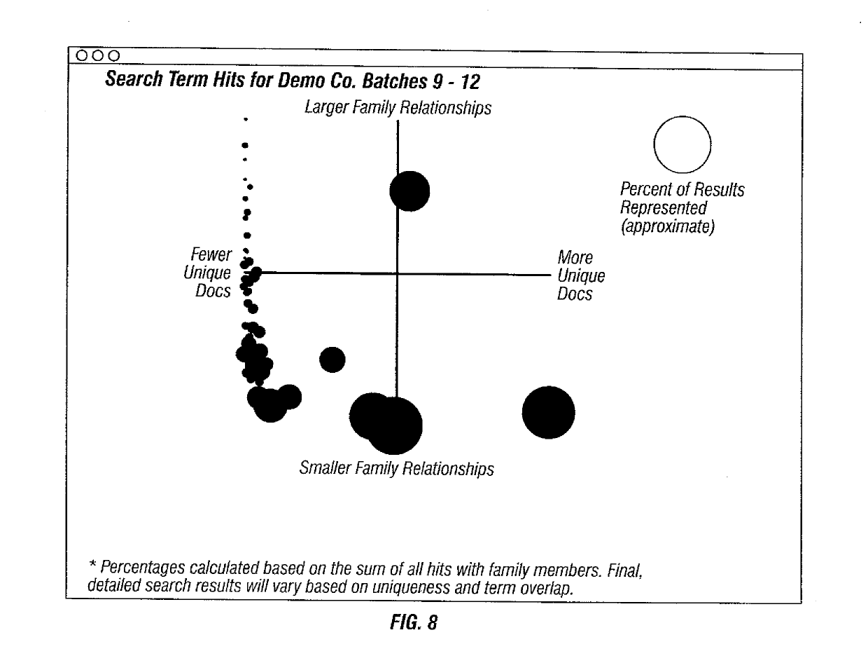

FIGS. 8-14 show an example that uses the Cartesian coordinate system. In this example, the X-axis describes how many unique documents versus non-unique documents that particular search term hit and is plotted relatively. In other words, the coordinates in this example are not using an absolute scale, but identify that the terms to the right have more unique documents than terms to the left. Similarly, in this example, there is a relative relationship on the Y-axis for family members. That is, terms that are higher up pull in more parents, children and siblings than lower positioned terms. So, as an example, a term corresponding to a point that plots near the bottom might pull in documents where one hit equals one resultant hit with parents and children; in contrast, a point that plots near the top might have three, four, or maybe ten parents, children or sibling documents perhaps because it is hitting on emails that are pulling in emails with attachments. In this example, the relative size of the points represents the search terms corresponding with the number of hits for the search term including family members. In this example, the user would be focusing on terms corresponding with larger points that are further to the right, and further up. The user could use the visualization tool in an interactive way to go through these terms and refine the analysis.

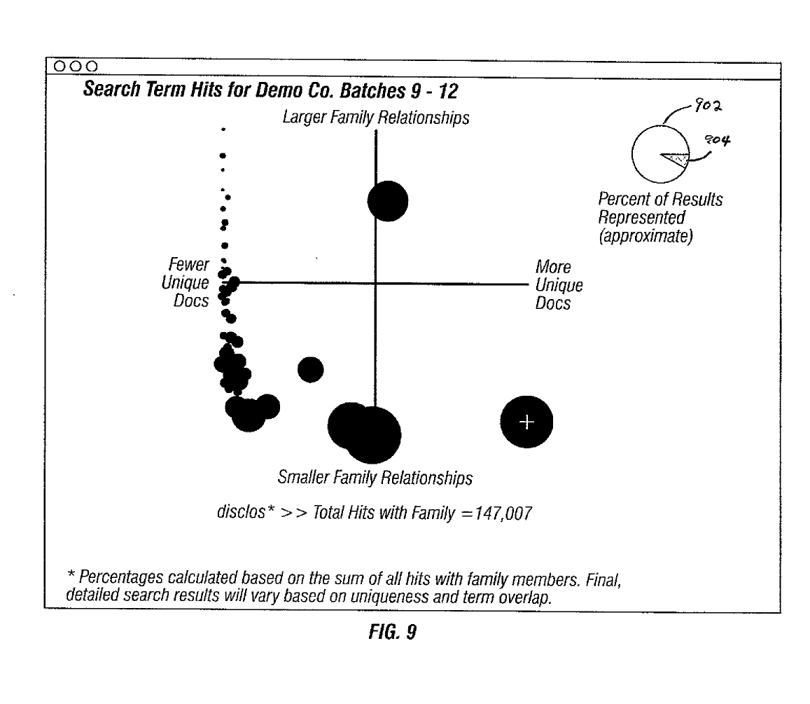

FIG. 9 shows an example when the user positioned the cursor 900 over the circle corresponding with the search term “disclos*”. When this happens, in this example, the user can see the detail about what the actual term was and the total hits with family members. In this case, the search term “disclose*” had 147,007 hits. This example also shows a pie chart 902 that identifies the term “disclos*” with respect to the current population of terms in the analysis. So this gives a quick perspective, the slice 904 on the pie chart 904 in this example, and so the user can see that “disclos*” is a small sliver in proportion to what is going on in total. Due to the relatively large size of the point in relation to the other points, which indicates a significant number of hits, and the position to the far to the right on the chart, this may be a good starting point for the analysis.

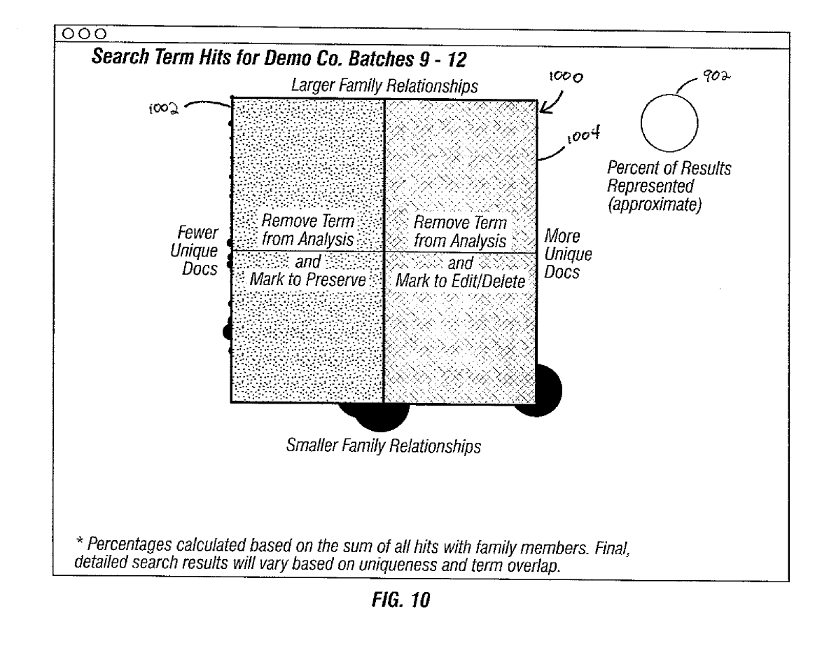

Consider an example where the user might look at this term and determine that it is getting more hits than intended. If this were the case, the user might want to either revisit, edit, or delete the term from the query. In this example, the user may select the point corresponding to the term “disclos*” to categorize the term and continue the analysis on to the next term with relevance. An example screen shot is shown in FIG. 10 with a window 1000 having a first option 1002 and a second option 1004. In this example, a selection of the first option 1002 marks the selected term to preserve and removes it from the analysis. If the second option 1004 were selected, the selected term would be edited/deleted and removed from the analysis.

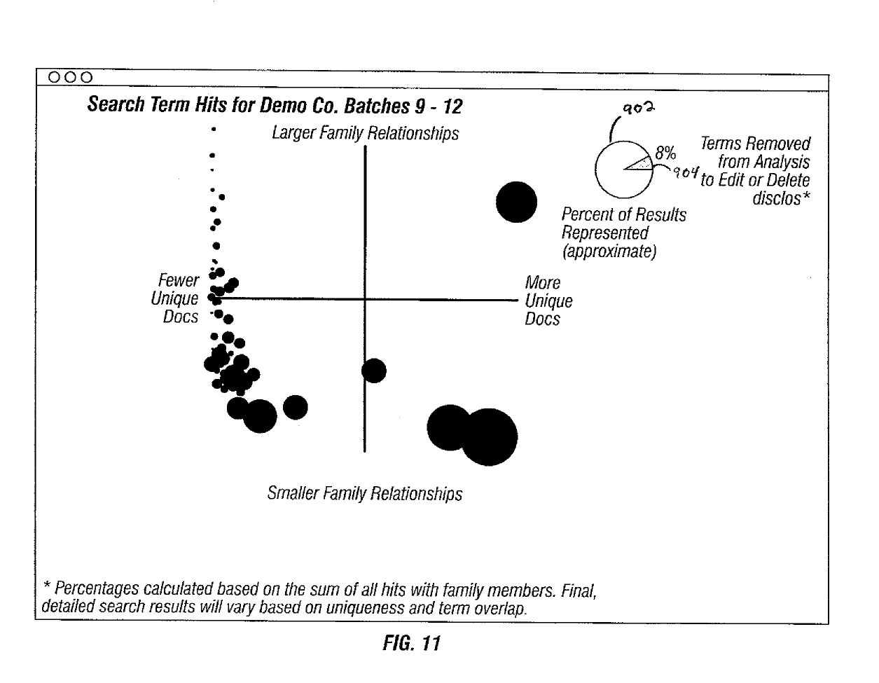

FIG. 11 shows an example in which the user selected the second option 1004, which deleted the term “disclos*” from the analysis. As can be seen in this example, the entire plot is recalculated assuming that that the term “disclos*” is no longer part of the population. Additionally, the pie chart 902 includes a segment 904 showing the term “disclos*” represents 8% of the total population. In some embodiments, the percentages in the relative weighting may be approximate. For example, the percentages could be calculating by summing up the calculations of all the hits with parents and children are across all the terms; however, there is some approximation in that because removing one term will not actually remove 8% of the population since some of the documents are unique, some of them overlap with other terms, and some of them have other different commingling effects with the rest of the results. However, this does give an approximate weighting of that term. Additionally, it can be seen in this example that the term “disclos*” now appears in a list of terms removed from analysis to edit or delete.

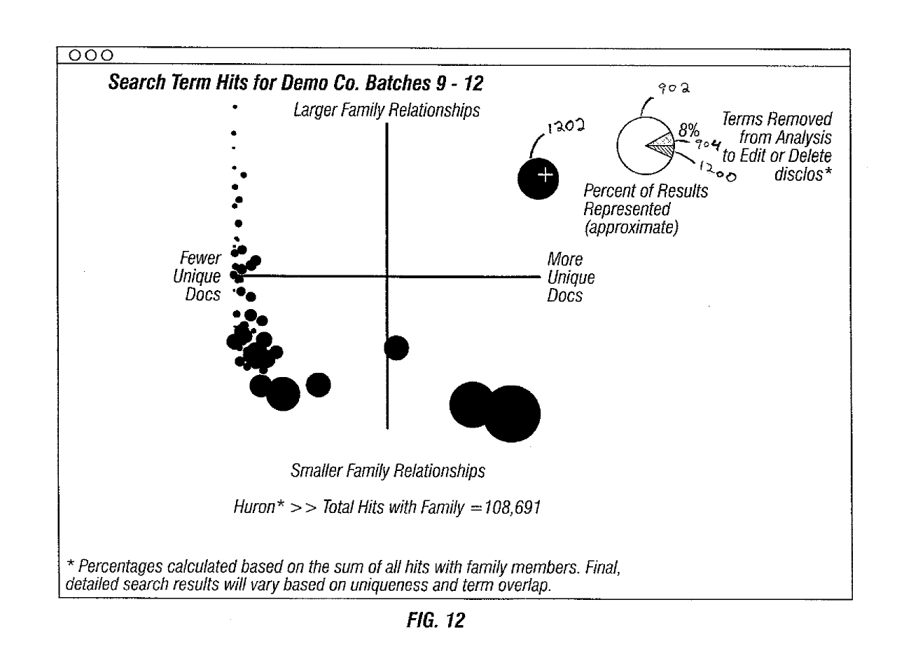

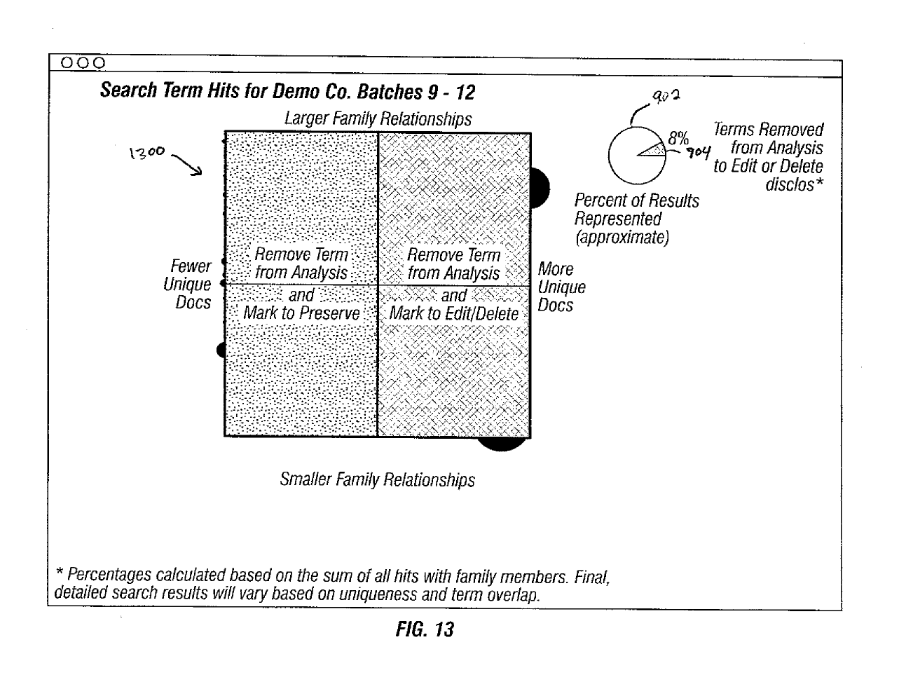

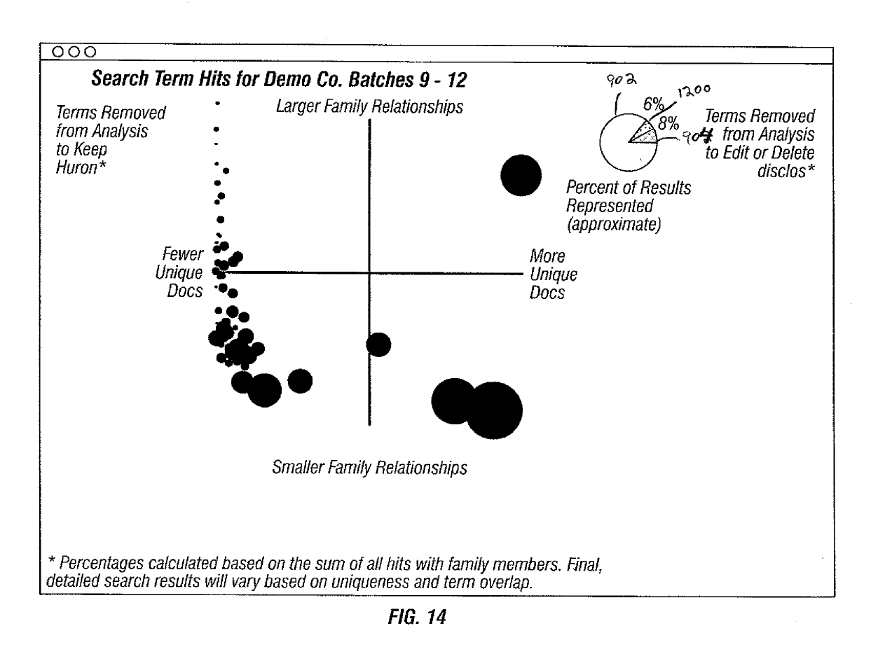

Referring now to FIG. 12, a cursor has selected a dot 1202 representing the term “Huron*”. When this term selected in this example, the relative weighting can be seen in the pie piece. In this example, the term “Huron*” had 108,691 hits. If the user would like to preserve this term, in this example, the user would click on that term to obtain the selection window 1300 shown in FIG. 13. As with the window 1000 shown in FIG. 10, the user may select to preserve the term. When this happens, the term “Huron*” appears in the list of terms to keep as shown in FIG. 14. The segment 1200 corresponding to the term “Huron*” is also shown in the pie chart. The example plot shown in FIG. 14 has been recalculated and the relative size of the bubbles and the relative position of the bubbles are recalculated to display their new relationships with the term “Huron*” removed from the analysis. The analysis could continue until the desired search terms have been categorized. In some embodiments, the visualization tool 118 could be configured to capture screen shots at various stages or other data for later retrieval.

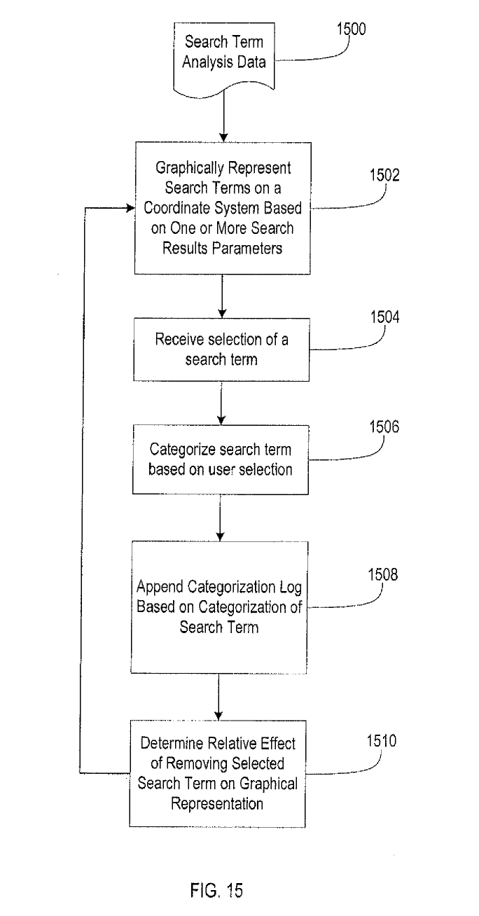

FIG. 15 is an example flow chart showing various steps that may be performed by the visualization tool 118. Search term analysis data may be provided for analysis (Block 1500). Based on the search term analysis data, the visualization tool 118 could graphically represent the search terms on a coordinate system based on one or more parameters (Block 1502). The visualization tool 118 may receive a selection of a search term, such as by using an input device 110 (Block 1504). The selected search term may be categorized depending on the input of the user (Block 1506). The visualization tool 118 may append the categorization log 206 as either a removed term or a preserved term (Block 1508). The visualization tool 118 may then graphically represent the remaining search terms on the coordinate system (Block 1510).

Although the present disclosure has been described with reference to particular means, materials, and embodiments from the foregoing description, one skilled in the art can easily ascertain the essential characteristics of the invention and various changes and modifications may be made to adapt the various uses and characteristics without departing from the spirit and scope of the invention.

What is claimed:

1. A system for visualizing an effect of search terms on search results, the system comprising:
a storage device configured to store a computer program and a data source, wherein the data source includes a plurality of search terms that are associated with a first search result parameter and a second search result parameter, and wherein the first search result parameter represents a first search result characteristic and the second relevance parameter represents a second search result characteristic;
a processor in communication with the storage device, wherein the computer program is operable, when executed by the processor, to cause the processor to perform steps comprising:
arranging the search terms on a coordinate system, wherein the first search result parameter corresponds to a first axis of the coordinate system and the second search result parameter corresponds to a second axis of the coordinate system; and
displaying a graphical representation of the search terms according to the arrangement of the first search result parameter and the second search result parameter on the coordinate system.

2. The system of claim 1, wherein the coordinate system comprises a Cartesian coordinate system.

3. The system of claim 2, wherein the first search result parameter corresponds to the x-axis.

4. The system of claim 3, wherein the second search result parameter corresponds to the y-axis.

5. The system of claim 1, wherein each search term is graphically represented as a point with Cartesian coordinates defined by the first search result parameter and the second search result parameter.

6. The system of claim 5, wherein the point is graphically represented by a circle, oval, rectangle, square, triangle, or polygon.

7. The system of claim 5, wherein each point representing a search term has a relative size indicative of a number of hits for the search term.

8. The system of claim 1, wherein the first search result characteristic indicates a proportional number of hits with parent/child relationships for a search term.

9. The system of claim 1, wherein the second search result characteristic indicates a proportional number of hits for unique documents with a search term.

10. The system of claim 1, wherein the computer program causes the processor to remove a search term from the analysis upon receiving a selection of that search term.

11. The system of claim 10, wherein the selected search term is categorized responsive to input from the user.

12. A system for visualizing an effect of search terms on search results, the system comprising:
a search term analysis data comprising a plurality of search terms associated with at least one search result parameter;
a visualization module configured to graphically represent the search result parameter associated with the plurality of search terms in the search term analysis data in a relativistic fashion;
a search term calibration module configured to categorize the plurality of search terms into at least one of a first category and a second category responsive to selection by the user; and
a categorization log configured to store data concerning categorization of the plurality of search terms.

13. The system of claim 12, wherein the visualization module is configured to arrange the search terms on a coordinate system based on the search result parameter.

14. The system of claim 12, wherein the visualization module is configured to arrange points on a coordinate system representing search terms in which the relative coordinates of the points correspond with a relative magnitude of the search result parameter for respective search terms.

15. A non-transitory computer-readable storage medium with an executable program stored thereon for visualizing an effect of search terms on search results, wherein the program instructs a processor to perform steps comprising:
providing search term analysis data including a plurality of search terms that are associated with a first search result parameter and a second search result parameter, and wherein the first search result parameter represents a first search result characteristic and the second search result parameter represents a second search result characteristic;
arranging a plurality of search terms on a coordinate system, wherein the first search result parameter corresponds to a first axis of the coordinate system and the second search result parameter corresponds to a second axis of the coordinate system; and
displaying a graphical representation of the search terms according to the arrangement of search terms on the coordinate system.

16. The computer-readable storage medium of claim 15, wherein the coordinate system comprises a Cartesian coordinate system and wherein the first search result parameter corresponds to the x-axis and the second search result parameter corresponds to the y-axis.

17. The computer-readable storage medium of claim 15, wherein each search term is graphically represented as a point with Cartesian coordinates defined by the first search result parameter and the second search result parameter.

18. The computer-readable storage medium of claim 17, wherein the point is graphically represented by a circle, oval, rectangle, square, triangle, or polygon.

19. The computer-readable storage medium of claim 17, wherein each point representing a search term has a relative size indicative of a number of hits for the search term.

20. The system of claim 15, wherein the first search result characteristic indicates a proportional number of hits with parent/child relationships for a search term.
